(19) United States
(12) Patent Application Publication
(10) Pub. No.: US 2023/0184187 A1
(43) Pub. Date: Jun. 15, 2023

(54) CONTROLLER FOR INTERNAL COMBUSTION ENGINE

(71) Applicant: Mitsubishi Electric Corporation, Tokyo (JP)

(72) Inventor: Tatsuhiko TAKAHASHI, Tokyo (JP)

(73) Assignee: Mitsubishi Electric Corporation, Tokyo (JP)

(21) Appl. No.: 18/051,373

(22) Filed: Oct. 31, 2022

(30) Foreign Application Priority Data
Dec. 9, 2021 (JP) 2021-199867

(51) Int. Cl. F02D 41/00; F02D 41/38; F02P 5/15; F02D 13/02

(52) U.S. Cl. CPC F02D 41/009; F02D 41/005; F02D 41/38; F02P 5/1502; F02D 13/0215

(57) ABSTRACT

To provide a controller for internal combustion engine which can suppress deterioration of the detection accuracy of the combustion state due to influence of the external disturbance component, when detecting a combustion state based on angle detection information by the crank angle sensor. A controller for internal combustion engine calculates a shaft torque in unburning; calculates an external load torque based on the shaft torque in unburning and the actual shaft torque in the vicinity of the top dead center; and in an integration crank angle interval which is set corresponding to a combustion period, calculates a subtraction value by subtracting the external load torque from the shaft torque in unburning, calculates a division value by dividing the subtraction value by the inertia moment, and calculates a combustion state index by integrating a value obtained by subtracting the division value from the crank angle acceleration.

### INCORPORATION BY REFERENCE

The disclosure of Japanese Patent Application No. 2021-199867 filed on Dec. 9, 2021 including its specification, claims and drawings, is incorporated herein by reference in its entirety.

### BACKGROUND

The present disclosure relates to a controller for internal combustion engine.

In the technology of JP H07-332151 A, the crank angle speed in the compression stroke is integrated in the range from the bottom dead center to the top dead center, the crank angle speed in the expansion stroke is integrated in the range from the top dead center to the bottom dead center, and the mean effective pressure is calculated by subtracting the integration value of the crank angle speed in the compression stroke from the integration value of the crank angle speed in the expansion stroke.

### SUMMARY

However, influence of the external load torque, such as reaction force from the road surface, is included in the crank angle speed. And, in the case of the internal combustion engine which has a plurality of cylinders, the influence of other cylinders is included in the crank angle speed. Accordingly, like the technology of JP H07-332151 A, only by integrating the crank angle speed, the detection accuracy of the mean effective pressure of the combustion cylinder is deteriorated due to influence of the external disturbance components, such as the external load torque and other cylinders.

Then, the purpose of the present disclosure is to provide a controller for internal combustion engine which can suppress deterioration of the detection accuracy of a combustion state due to influence of the external disturbance component, such as the external load torque, included in angle detection information, when detecting the combustion state based on angle detection information by the crank angle sensor.

A controller for internal combustion engine according to the present disclosure including:

an angle information detection unit that detects a crank angle and a crank angle acceleration, based on an output signal of a crank angle sensor;

an unburning shaft torque calculation unit that calculates a shaft torque in unburning when assuming that an internal combustion engine is unburning condition, at each crank angle;

an external load torque calculation unit that calculates an external load torque which is a torque applied to a crankshaft from an outside of the internal combustion engine, based on the shaft torque in unburning at the crank angle in a vicinity of a top dead center of a combustion stroke, and an actual shaft torque obtained by multiplying an inertia moment of a crankshaft system to the crank angle acceleration at the crank angle in the vicinity of the top dead center;

a combustion index calculation unit that, in an integration crank angle interval which is set corresponding to a combustion period, calculates a subtraction value of each crank angle by subtracting the external load torque from the shaft torque in unburning of each crank angle, calculates a division value of each crank angle by dividing the subtraction value of each crank angle by the inertia moment, and calculates a combustion state index by integrating a value obtained by subtracting the division value of each crank angle from the crank angle acceleration of each crank angle.

A controller for internal combustion engine according to the present disclosure including:

an angle information detection unit that detects a crank angle and a crank angle acceleration, based on an output signal of a crank angle sensor;

an unburning acceleration calculation unit that calculates a crank angle acceleration in unburning when assuming that an internal combustion engine is unburning condition, at each crank angle;

an external load acceleration calculation unit that calculates an external load acceleration component which is a crank angle acceleration component by an external load torque applied to a crankshaft from an outside of an internal combustion engine, based on the crank angle acceleration in unburning at the crank angle in a vicinity of a top dead center of a combustion stroke, and the crank angle acceleration at the crank angle in the vicinity of the top dead center;

a combustion index calculation unit that, in an integration crank angle interval which is set corresponding to a combustion period, calculates a subtraction value of each crank angle by subtracting the crank angle acceleration in unburning of each crank angle from the crank angle acceleration of each crank angle, and calculates a combustion state index by integrating a value obtained by adding the external load acceleration component to the subtraction value of each crank angle.

According to the controller for internal combustion engine of the present disclosure, the value obtained by multiplying the inertia moment to the integration object value corresponds to an increment of gas pressure torque by burning. The increment of gas pressure torque by burning is a torque generated by the increase in the gas pressure (the cylinder internal pressure) by burning, and is basically become 0 except the combustion period. Accordingly, the combustion state index which is the integration value in the integration crank angle interval corresponding to the combustion period corresponds to a work load by burning in one combustion cycle. On the other hand, the indicated mean effective pressure corresponds to a work load in one combustion cycle obtained by integrating the cylinder internal pressure about the cylinder volume, and mainly becomes a value according to the integration value of the increment of cylinder pressure by burning. Therefore, the combustion state index corresponds to the indicated mean effective pressure. Accordingly, an equivalent value of the indicated mean effective pressure can be calculated by the combustion state index, and the combustion state can be evaluated. Since the external load torque or the external load acceleration component is calculated and it is reflected in calculation of the combustion state index, calculation accuracy of the combustion state index can be suppressed from deteriorating.

### BRIEF DESCRIPTION OF THE DRAWINGS

FIG. 1 is a schematic configuration diagram of the internal combustion engine and the controller according to Embodiment 1;

FIG. 2 is a schematic configuration diagram of the internal combustion engine and the controller according to Embodiment 1;

FIG. 3 is a block diagram of the controller according to Embodiment 1;

FIG. 4 is a hardware configuration diagram of the controller according to Embodiment 1;

FIG. 5 is a time chart for explaining an angle information detection processing according to Embodiment 1;

FIG. 6 is a time chart for explaining the angle information calculation processing according to Embodiment 1;

FIG. 7 is a figure for explaining the cylinder pressure in unburning and the cylinder pressure in burning according to Embodiment 1;

FIG. 8 is a figure explaining the unburning condition shaft torque data according to Embodiment 1;

FIG. 9 is a flowchart showing the procedure of schematic processing of the controller according to Embodiment 1;

FIG. 10 is a block diagram of the controller according to Embodiment 2; and

FIG. 11 is a flowchart showing the procedure of schematic processing of the controller according to Embodiment 2.

### DETAILED DESCRIPTION OF THE EMBODIMENTS

### 1. Embodiment 1

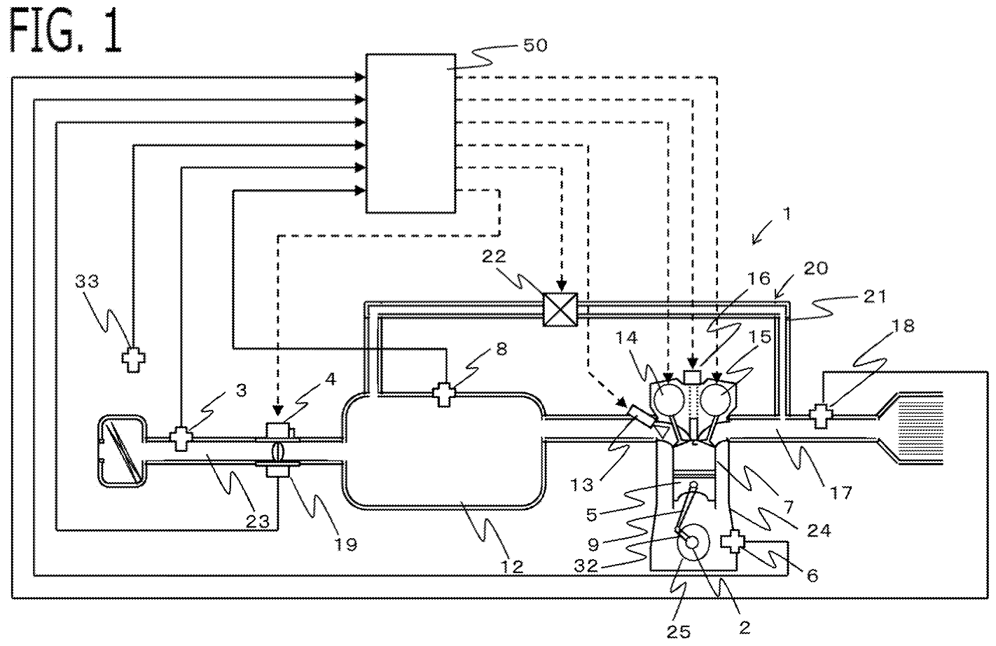

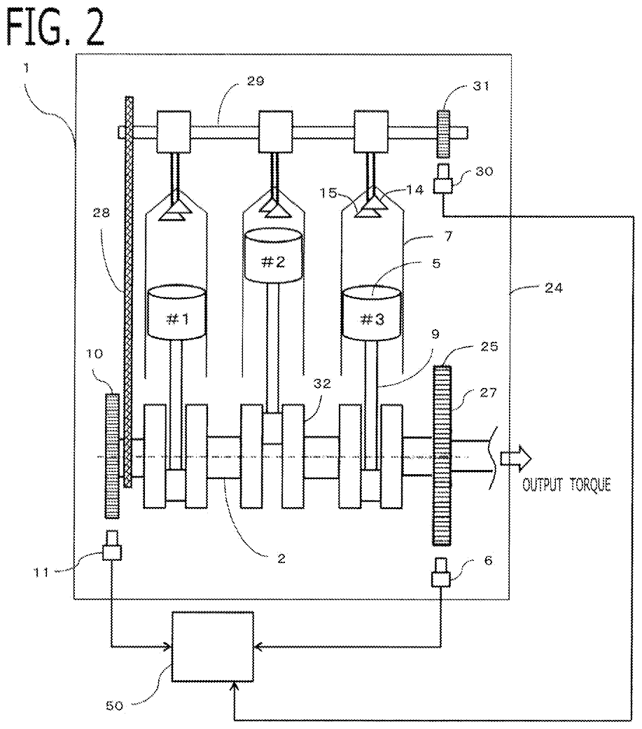

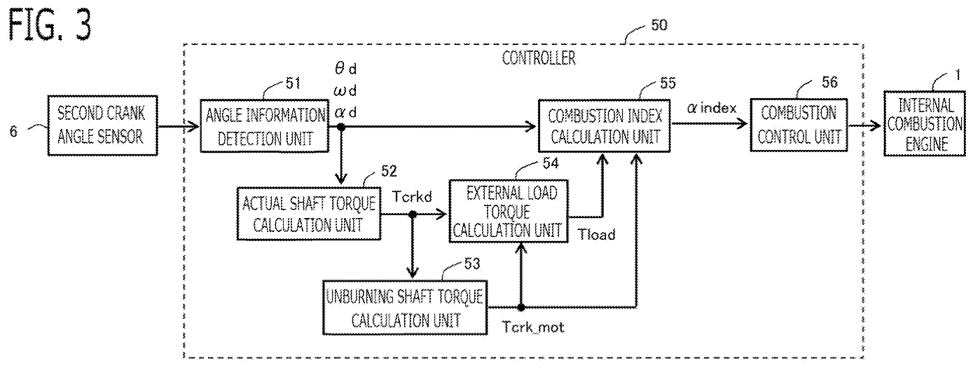

A controller 50 for internal combustion engine (hereinafter, referred to simply as the controller 50) according to Embodiment 1 will be explained with reference to the drawings. FIG. 1 and FIG. 2 are a schematic configuration diagram of the internal combustion engine 1 and the controller 50; FIG. 3 is a block diagram of the controller 50 according to Embodiment 1. The internal combustion engine 1 and the controller 50 are mounted in a vehicle, and the internal combustion engine 1 functions as a driving-force source for the vehicle (wheels).

### 1-1. Configuration of Internal Combustion Engine 1

The configuration of the internal combustion engine 1 will be explained. As shown in FIG. 1, the internal combustion engine 1 is provided with cylinders 7 in which a fuel-air mixture is combusted. The internal combustion engine 1 is provided with an intake path 23 for supplying air to the cylinders 7 and an exhaust path 17 for discharging exhaust gas from the cylinders 7. The internal combustion engine 1 is a gasoline engine. The internal combustion engine 1 is provided with a throttle valve 4 which opens and closes intake path 23. The throttle valve 4 is an electronically controlled throttle valve which is opening/closing-driven by an electric motor controlled by controller 50. A throttle position sensor 19 which outputs an electric signal according to the opening degree of the throttle valve 4 is provided in the throttle valve 4.

An air flow sensor 3 which outputs an electric signal according to an intake air amount taken into the intake path 23 is provided in the intake path 23 on the upstream side of throttle valve 4. The internal combustion engine 1 is provided with an exhaust gas recirculation apparatus 20. The exhaust gas recirculation apparatus 20 has an EGR passage 21 which recirculates the exhaust gas from the exhaust path 17 to the intake manifold 12, and an EGR valve 22 which opens and closes the EGR passage 21. The intake manifold 12 is a part of the intake path 23 on the downstream side of the throttle valve 4. The EGR valve 22 is an electronic controlled EGR valve which is opening/closing-driven by an electric motor controlled by controller 50. An air-fuel ratio sensor 18 which outputs an electric signal according to an air-fuel ratio of exhaust gas in the exhaust path 17 is provided in the exhaust path 17.

A manifold pressure sensor 8 which outputs an electric signal according to a pressure in the intake manifold 12 is provided in the intake manifold 12. An injector 13 for injecting a fuel is provided on the downstream side part of the intake manifold 12. The injector 13 may be provided so as to inject a fuel directly into the cylinder 7. An atmospheric pressure sensor 33 which outputs an electric signal according to an atmospheric pressure is provided in the internal combustion engine 1.

An ignition plug for igniting a fuel-air mixture and an ignition coil 16 for supplying ignition energy to the ignition plug are provided on the top of the cylinder 7. An intake valve 14 for adjusting the amount of intake air to be taken from the intake path 23 into the cylinder 7 and an exhaust valve 15 for adjusting the amount of exhaust gas to be exhausted from the cylinder to the exhaust path 17 are provided on the top of the cylinder 7. The intake valve 14 is provided with an intake variable valve timing mechanism which makes the opening and closing timing thereof variable. The exhaust valve 15 is provided with an exhaust variable valve timing mechanism which makes the opening and closing timing thereof variable. Each of the variable valve timing mechanisms 14, 15 has an electric actuator.

As shown in FIG. 2, the internal combustion engine 1 has a plurality of cylinders 7 (in this example, three). A piston 5 is provided inside of the each cylinder 7. The piston 5 of each cylinder 7 is connected to a crankshaft 2 via a connecting rod 9 and a crank 32. The crankshaft 2 is rotated by reciprocating movement of the piston 5. A combustion gas pressure generated in each cylinder 7 presses the top face of the piston 5, and rotates the crankshaft 2 via the connecting rod 9 and the crank 32. The crankshaft 2 is connected with a power transfer mechanism which transmits driving force to the wheels. The power transfer mechanism is provided with a gearbox, a differential gear, and the like. The vehicle provided with the internal combustion engine 1 may be a hybrid vehicle provided with a motor generator in the power transfer mechanism.

The internal combustion engine 1 is provided with a signal plate 10 which rotates integrally with the crankshaft 2. A plurality of teeth are provided in the signal plate 10 at a plurality of preliminarily set crank angles. In the present embodiment, the teeth of the signal plate 10 are arranged at intervals of 10 degrees. The teeth of the signal plate 10 are provided with a chipped tooth part in which a part of teeth is chipped. The internal combustion engine 1 is provided with a first crank angle sensor 11 which is fixed to an engine block 24 and detects the tooth of the signal plate 10.

The internal combustion engine 1 is provided with a cam shaft 29 connected with crankshaft 2 via a chain 28. The cam shaft 29 carries out the opening-and-closing drive of the intake valve 14 and the exhaust valve 15. During the crankshaft 2 rotates two times, the cam shaft 29 rotates once. The internal combustion engine 1 is provided with a signal plate 31 for cam which rotates integrally with the cam shaft 29. A plurality of teeth are provided in the signal plate 31 for cam at a plurality of preliminarily set cam shaft angles. The internal combustion engine 1 is provided with a cam angle sensor 30 which is fixed to an engine block 24 and detects the tooth of signal plate 31 for cam.

Based on two kinds of output signals of the first crank angle sensor 11 and the cam angle sensor 30, the controller 50 detects the crank angle on the basis of the top dead center of each piston 5 and determines the stroke of each cylinder 7. The internal combustion engine 1 is a 4-stroke engine which has an intake stroke, a compression stroke, a combustion stroke, and an exhaust stroke.

The internal combustion engine 1 is provided with a flywheel 27 which rotates integrally with the crankshaft 2. The peripheral part of flywheel 27 is a ring gear 25, and a plurality of teeth are provided in the ring gear 25 at a plurality of preliminarily set crank angles. The teeth of the ring gear 25 are arranged in the peripheral direction with equiangular intervals. In this example, 90 teeth are provided with intervals of 4 degrees. The teeth of ring gear 25 are not provided with a chipped tooth part. The internal combustion engine 1 is provided with a second crank angle sensor 6 which is fixed to the engine block 24 and detects the tooth of the ring gear 25. The second crank angle sensor 6 is disposed oppositely to the ring gear 25 with a space in radial-direction outside of the ring gear 25. The opposite side of the flywheel 27 to the crankshaft 2 is connected with a power transfer mechanism. Accordingly, the output torque of the internal combustion engine 1 passes through a part of the flywheel 27, and is transmitted to the wheels side.

Each of the first crank angle sensor 11, the cam angle sensor 30, and the second crank angle sensor 6 outputs an electric signal according to change of the distance between each sensor and tooth by rotation of the crankshaft 2. The output signal of each angle sensor 11, 30, 6 becomes a rectangular wave that a signal turns on or off when the distance between sensor and tooth is near or when the distance is far. An electromagnetic pickup type sensor is used for each angle sensor 11, 30, 6, for example.

Since the flywheel 27 (the ring gear 25) has larger number of teeth than the number of teeth of the signal plate 10, and there is also no chipped tooth part, a high resolution angle detection can be expected. Since the flywheel 27 has larger mass than the mass of the signal plate 10 and high frequency oscillation is suppressed, a high accuracy of angle detection can be expected.

### 1-2. Configuration of Controller 50

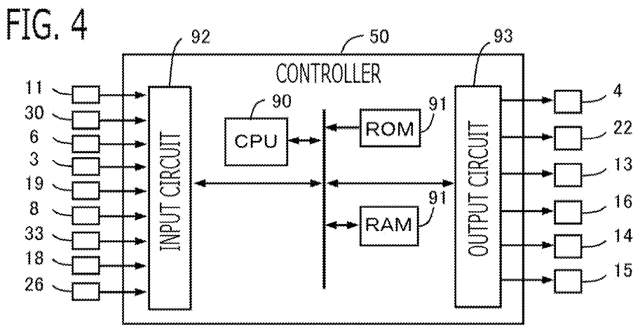

Next, the controller 50 will be explained. The controller 50 is the one whose control object is the internal combustion engine 1. As shown in FIG. 3, the controller 50 is provided with control units of an angle information detection unit 51, an actual shaft torque calculation unit 52, an unburning shaft torque calculation unit 53, an external load torque calculation unit 54, a combustion index calculation unit 55, a combustion control unit 56, and the like. The respective control units 51 to 56 of the controller 50 are realized by processing circuits included in the controller 50. Specifically, as shown in FIG. 4, the controller 50 is provided with, as a processing circuit, an arithmetic processor (computer) 90 such as a CPU (Central Processing Unit), storage apparatuses 91 which exchange data with the arithmetic processor 90, an input circuit 92 which inputs external signals to the arithmetic processor 90, an output circuit 93 which outputs signals from the arithmetic processor 90 to the outside, and the like.

As the arithmetic processor 90, ASIC (Application Specific Integrated Circuit), IC (Integrated Circuit), DSP (Digital Signal Processor), FPGA (Field Programmable Gate Array), various kinds of logical circuits, various kinds of signal processing circuits, and the like may be provided. As the arithmetic processor 90, a plurality of the same type ones or the different type ones may be provided, and each processing may be shared and executed.

As the storage apparatus 91, volatile and nonvolatile storage apparatuses, such as RAM (Random Access Memory), ROM (Read Only Memory), and EEPROM (Electrically Erasable Programmable ROM), are provided. The input circuit 92 is connected with various kinds of sensors and switches and is provided with an A/D converter and the like for inputting output signals from the sensors and the switches to the arithmetic processor 90. The output circuit 93 is connected with electric loads and is provided with a driving circuit and the like for outputting a control signal from the arithmetic processor 90.

Then, the arithmetic processor 90 runs software items (programs) stored in the storage apparatus 91 such as a ROM and collaborates with other hardware devices in the controller 50, such as the storage apparatus 91, the input circuit 92, and the output circuit 93, so that the respective functions of the control units 51 to 56 provided in the controller 50 are realized. Setting data items, such as an unburning condition shaft torque data, an inertia moment Icrk, and a determination value to be used in the control units 51 to 56 are stored, as part of software items (programs), in the storage apparatus 91 such as ROM and EEPROM. Data of calculation values and detection values, such as a crank angle θd, a crank angle acceleration ad, an external load torque Tload, and a combustion state index αindex, which are calculated by the control units 51 to 56 is stored in the storage apparatus 91, such as RAM.

In the present embodiment, the input circuit 92 is connected with the first crank angle sensor 11, the cam angle sensor 30, the second crank angle sensor 6, the air flow sensor 3, the throttle position sensor 19, the manifold pressure sensor 8, the atmospheric pressure sensor 33, the air fuel ratio sensor 18, an accelerator position sensor 26, and the like. The output circuit 93 is connected with the throttle valve 4 (electric motor), the EGR valve 22 (electric motor), the injector 13, the ignition coil 16, the intake-air variable valve timing mechanism 14, the exhaust-gas variable valve timing mechanism 15, and the like. The controller 50 is connected with various kinds of unillustrated sensors, switches, actuators, and the like. The controller 50 detects operating conditions of the internal combustion engine 1, such as an intake air amount, a pressure in the intake manifold, an atmospheric pressure, an air-fuel ratio, and an accelerator opening degree, based on the output signals of various sensors.

As basic control, the controller 50 calculates a fuel injection amount, an ignition timing, and the like, based on inputted output signals and the like from the various kinds of sensors, and then performs driving control of the injector 13, the ignition coil 16, and the like. Based on the output signal of the accelerator position sensor 26 and the like, the controller 50 calculates an output torque of the internal combustion engine 1 demanded by the driver, and then controls the throttle valve 4 and the like so that an intake air amount for realizing the demanded output torque is obtained. Specifically, the controller 50 calculates a target throttle opening degree and then performs driving control of the electric motor of the throttle valve 4 so that the throttle opening degree which is detected based on the output signal of the throttle position sensor 19 approaches the target throttle opening degree. And, the controller 50 calculates a target opening degree of the EGR valve 22 based on inputted output signals and the like from the various kinds of sensors and then performs driving control of the electric motor of the EGR valve 22. The controller 50 calculates a target opening and closing timing of the intake valve and a target opening and closing timing of the exhaust valve based on the output signals of the various sensors, and performs driving control of the intake and the exhaust variable valve timing mechanisms 14, 15 based on each target opening and closing timing.

### 1-2-1. Angle Information Detection Unit 51

The angle information detection unit 51 detects a crank angle θd, a crank angle speed ωd which is a time change rate of the crank angle θd, and a crank angle acceleration ad which is a time change rate of the crank angle speed ωd, based on the output signal of the second crank angle sensor 6.

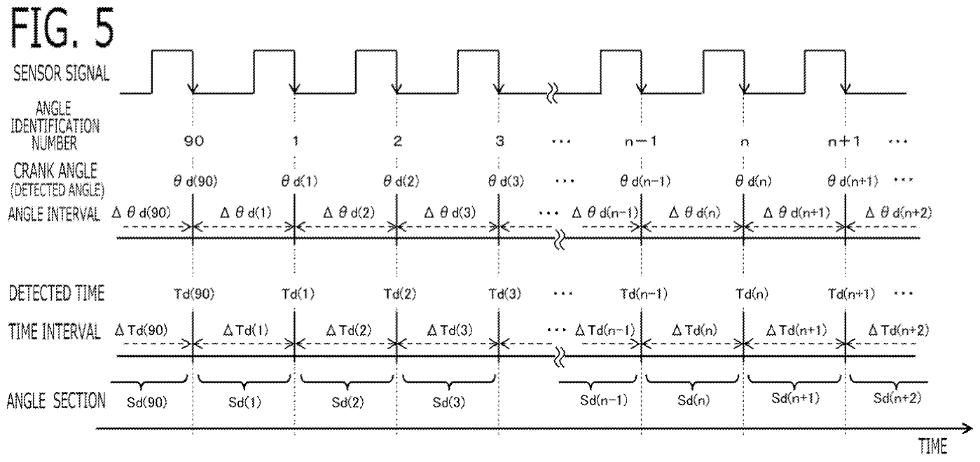

In the present embodiment, as shown in FIG. 5, the angle information detection unit 51 detects the crank angle θd based on the output signal of the second crank angle sensor 6 and detects a detected time Td at which the crank angle θd is detected. Then, based on a detected angle θd which is the detected crank angle θd, and the detected time Td, the angle information detection unit 51 calculates an angle interval Δθd and a time interval ΔTd corresponding to an angle section Sd between the detected angles θd.

In the present embodiment, the angle information detection unit 51 determines the crank angle θd when a falling edge (or rising edge) of the output signal (rectangular wave) of the second crank angle sensor 6 is detected. The angle information detection unit 51 determines a basing point falling edge which is a falling edge corresponding to a basing point angle (for example, 0 degree which is a top dead center of the piston 5 of the first cylinder #1), and determines the crank angle θd corresponding to a number n of the falling edge which is counted up on the basis of the basing point falling edge (hereinafter, referred to as an angle identification number n). For example, when the basing point falling edge is detected, the angle information detection unit 51 sets the crank angle θd to the basing point angle (for example, 0 degree), and sets the angle identification number n to 1. Then, every time the falling edge is detected, the angle information detection unit 51 increases the crank angle θd by a preliminarily set angle interval Δθd (in this example, 4 degrees) and increases the angle identification number n by one. Alternatively, the angle information detection unit 51 may read out the crank angle θd corresponding to the this time identification number n, by use of an angle table in which a relationship between the angle identification number n and the crank angle θd is preliminarily set. The angle information detection unit 51 correlates the crank angle θd (the detected angle θd) with the angle identification number n. The angle identification number n returns to 1 after a maximum number (in this example, 90). The last time angle identification number n of the angle identification number n=1 is 90, and the next time angle identification number n of the angle identification number n=90 is 1.

In the present embodiment, as described later, the angle information detection unit 51 determines the basing point falling edge of the second crank angle sensor 6 with reference to a reference crank angle detected based on the first crank angle sensor 11 and the cam angle sensor 30. For example, the angle information detection unit 51 determines the falling edge at which the reference crank angle when the falling edge of the second crank angle sensor 6 is detected becomes the closest to the basing point angle, as the basing point falling edge.

The angle information detection unit 51 determines the stroke of each cylinder 7 corresponding to the crank angle θd with reference to the stroke of each cylinder 7 determined based on the first crank angle sensor 11 and the cam angle sensor 30.

The angle information detection unit 51 detects a detected time Td when the falling edge of the output signal (rectangular wave) of the second crank angle sensor 6 is detected, and correlates the detected time Td with the angle identification number n. Specifically, the angle information detection unit 51 detects the detected time Td using the timer function provided in the arithmetic processor 90.

As shown in FIG. 5, when the falling edge is detected, the angle information detection unit 51 sets the angle section between the detected angle θd(n) corresponding to the this time angle identification number (n) and the detected angle θd(n−1) corresponding to the last time angle identification number (n−1), as the angle section Sd(n) corresponding to the this time angle identification number (n).

As shown in the equation (1), when the falling edge is detected, the angle information detection unit 51 calculates a deviation between the detected angle θd(n) corresponding to the this time angle identification number (n) and the detected angle θd(n−1) corresponding to the last time angle identification number (n−1), and sets the calculated deviation as the angle interval Δθd(n) corresponding to the this time angle identification number (n) (the this time angle section Sd(n)).

Δθd(n)=θd(n)−θd(n−1) (1)

In the present embodiment, since all the angle intervals of the tooth of ring gear 25 are made equal, the angle information detection unit 51 sets the angle interval Δθd of all the angle identification numbers n as a preliminarily set angle (in this example, 4 degrees).

As shown in the equation (2), when the falling edge is detected, the angle information detection unit 51 calculates a deviation between the detected time Td(n) corresponding to the this time angle identification number (n) and the detected time Td(n−1) corresponding to the last time angle identification number (n−1), and sets the calculated deviation as the time interval ΔTd(n) corresponding to the this time angle identification number (n) (the this time angle section Sd(n)).

ΔTd(n)=Td(n)−Td(n−1) (2)

Based on two kinds of output signals of the first crank angle sensor 11 and the cam angle sensor 30, the angle information detection unit 51 detects the reference crank angle on the basis of the top dead center of the piston 5 of the first cylinder #1, and determines the stroke of each cylinder 7. For example, the angle information detection unit 51 determines the falling edge just after the chipped tooth part of the signal plate 10 based on the time interval of the falling edge of the output signal (rectangular wave) of the first crank angle sensor 11. Then, the angle information detection unit 51 determines a correspondency between the each falling edge on the basis of the falling edge just after the chipped tooth part, and the reference crank angle on the basis of the top dead center, and calculates the reference crank angle on the basis of the top dead center when each falling edge is detected. The angle information detection unit 51 determines the stroke of each cylinder 7 based on the relationship between the position of the chipped tooth part in the output signal (rectangular wave) of the first crank angle sensor 11, and the output signal (rectangular wave) of the cam angle sensor 30.

### <Filter Processing>

The angle information detection unit 51 performs a filter processing which removes a high frequency error component, when calculating the crank angle acceleration αd. The angle information detection unit 51 performs the filter processing to the time interval ΔTd. The time interval ΔTd is a crank angle period ΔTd which is a period of a unit angle (in this example, 4 degrees). As the filter processing, for example, a finite impulse response (FIR) filter is used. The high frequency component caused by the production variation of teeth and the like is reduced by the filter processing.

For example, as the FIR filter, the processing shown in the equation (3) is performed.

$$Δ Tdf ( n ) = {\sum }_{j = 0}^{N} {b}_{j} Δ Td ( n - j ) \qquad ( 3 )$$

Herein, ΔTdf(n) is a time interval (a crank angle period) after filter, N is an order of the filter, and bj is a coefficient of the filter.

The angle information detection unit 51 performs the filter processing with the same filter characteristics between the unburning condition and the burning condition. In this example, the order N of the filter and the each coefficient of the filter are set to the same values between the unburning condition and the burning condition.

The filter processing which removes the high frequency error component may be performed to the crank angle speed ωd(n) described below, instead of the time interval ΔTd. Alternatively, the filter processing may not be performed when calculating the crank angle acceleration αd.

Instead of the filter processing or with the filter processing, the angle information detection unit 51 may correct the time interval ΔTd(n) of each angle identification number n by a correction coefficient Kc(n) which is set corresponding to each angle identification number n. The correction coefficients Kc(n) are learned based on the time intervals ΔTd(n) using the method disclosed in JP 6169214 B and the like, or are preliminarily set by matching in production.

<Calculation of Crank Angle Speed ωd and Crank Angle Acceleration αd>

Based on the angle interval Δθd and the time interval after filter ΔTdf, the angle information detection unit 51 calculates a crank angle speed ωd which is a time change rate of the crank angle θd, and a crank angle acceleration ad which is a time change rate of the crank angle speed ωd, corresponding to each of the detected angle θd or the angle interval Sd.

In the present embodiment, as shown in FIG. 6, based on the angle interval Δθd(n) and the time interval ΔTdf(n) corresponding to the angle interval Sd(n) set to the processing object, the angle information detection unit 51 calculates the crank angle speed ωd(n) corresponding to the angle interval Sd(n) of the processing object. Specifically, as shown in the equation (4), the angle information detection unit 51 calculates the crank angle speed ωd(n) by dividing the angle interval Δθd(n) corresponding to the angle interval Sd(n) of the processing object by the time interval after filter ΔTdf(n).

$$ω d ( n ) = \frac{Δ θ d ( n )}{Δ Tdf ( n )} \times \frac{π}{180} \qquad ( 4 )$$

Based on the crank angle speed ωd(n) and the time interval after filter ΔTdf(n) corresponding to the just before one angle interval Sd(n) of the detected angle θd(n) set to the processing object, and the crank angle speed ωd(n+1) and the time interval after filter ΔTdf(n+1) corresponding to the just after one angle interval Sd(n+1) of the detected angle θd(n) set to the processing object, the angle information detection unit 51 calculates the crank angle acceleration αd(n) corresponding to the detected angle θd(n) of the processing object. Specifically, as shown in the equation (5), the angle information detection unit 51 calculates the crank angle acceleration αd(n) by dividing a subtraction value obtained by subtracting the just before crank angle speed ωd(n) from the just after crank angle speed ωd(n+1), by an average value of the just after time interval after filter ΔTdf (n+1) and the just before time interval after filter ΔTdf(n).

$$α d ( n ) = \frac{ω d ( n + 1 ) - ω d ( n )}{Δ Tdf ( n + 1 ) + Δ Tdf ( n )} \times 2 \qquad ( 5 )$$

The angle information detection unit 51 stores angle information, such as the angle identification number n, the crank angle θd(n), the time interval before filter ΔTd(n), the time interval after filter ΔTdf(n), the crank angle speed ωd(n), and the crank angle acceleration αd(n), to the storage apparatus 91 such as RAM, during a period at least longer than the combustion stroke.

### 1-2-2. Actual Shaft Torque Calculation Unit 52

The actual shaft torque calculation unit 52 calculates an actual shaft torque Tcrkd applied to the crankshaft, based on the detection value of crank angle acceleration ad, and the inertia moment Icrk of the crankshaft system, at each crank angle θd including a crank angle θd_tdc in the vicinity of the top dead center.

Each crank angle θd at which the actual shaft torque Tcrkd is calculated may be limited to each crank angle θd at which the calculated actual shaft torque Tcrkd is used.

In the present embodiment, as shown in the next equation, the actual shaft torque calculation unit 52 calculates the actual shaft torque Tcrkd(n) by multiplying the inertia moment Icrk of the crankshaft system to the detection value of crank angle acceleration αd(n), at each crank angle θd(n).

Tcrkd(n)=αd(n)×Icrk (6)

The inertia moment Icrk of the crankshaft system is an inertia moment of the whole member which rotates integrally with the crankshaft 2 (for example, the crankshaft 2, the crank 32, the flywheel 27, and the like), and is preliminarily set.

The actual shaft torque calculation unit 52 stores the calculated actual shaft torque Tcrkd(n) to the storage apparatus 91 such as RAM, together with angle information such as corresponding the angle identification number n and the crank angle θd(n), during a period at least longer than the integration crank angle interval described below.

### 1-2-3. Unburning Shaft Torque Calculation Unit 53

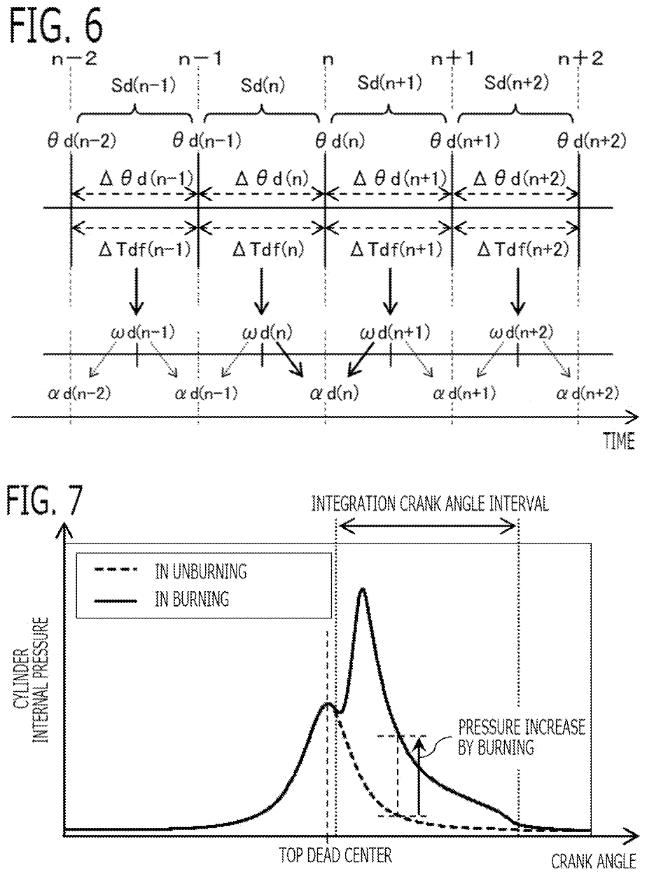

As shown in FIG. 7, the cylinder pressure in burning increases by a pressure increment by burning more than the cylinder pressure in unburning. As shown in the next equation, the actual shaft torque in burning Tcrkd_brn increases by an increment of shaft torque ΔTgas_brn generated by this pressure increment by burning more than the shaft torque in unburning Tcrk_mot. Since this increment of shaft torque ΔTgas_brn is an increment of gas pressure torque generated by the gas pressure increase which is an increase from the cylinder pressure in unburning (the gas pressure) to the cylinder pressure in burning (the gas pressure), it is referred to as an increment of gas pressure torque by burning ΔTgas_brn.

The shaft torque in unburning Tcrk_mot includes a gas pressure torque which is a torque applied to the crankshaft by a force of the gas pressure in each cylinder in unburning pushing the piston, and a reciprocation inertia torque which is a torque applied to the crankshaft by a reciprocation inertia of the piston of each cylinder. As described later, since the shaft torque in unburning Tcrk_mot does not include an external load torque Tload, as shown in the next equation, it is necessary to subtract the external load torque Tload. The external load torque Tload is a torque applied to the crankshaft from the outside of the internal combustion engine. The external load torque Tload includes a running resistance and a frictional resistance of the vehicle which are transmitted to the internal combustion engine from the power transfer mechanism connected with the wheels, and an auxiliary machine load, such as the alternator connected with the crankshaft.

Tcrkd_brn=Tcrk_mot+ΔTgas_brr−Tload (7)

In the vicinity of the top dead center, the connecting rod and the crank become in a straight line, and the shaft torque Tcrk is not generated by the force of the cylinder pressure pushing the piston. Accordingly, in the vicinity of the top dead center of the compression stroke, the increment of shaft torque by burning ΔTgas_brn becomes 0. Therefore, as shown in the next equation obtained by modifying the equation (7), by subtracting the actual shaft torque in this time burning Tcrkd_brn_tdc in the vicinity of the top dead center from the shaft torque in unburning Tcrk_mot_tdc in the vicinity of the top dead center, this time external load torque Tload can be calculated.

ΔTgas_brn_tdc=0

Tload=Tcrk_mot_tdr−Tcrkd_bur_tdc (8)

Since the external load torque Tload does not fluctuate largely in the stroke period, the external load torque Tload calculated in the vicinity of the top dead center can be used at each crank angle θd.

In the present disclosure, “burning condition” and “in burning” are a condition and a time that the controller 50 controls so as to burn fuel in the combustion stroke. And, “unburning condition” and “in unburning” are a condition and a time that the controller 50 controls so as not to burn fuel in the combustion stroke.

### <Calculation of Shaft Torque in Unburning>

The unburning shaft torque calculation unit 53 calculates a shaft torque in unburning Tcrk_mot when assuming that the internal combustion engine is unburning condition in the present driving condition, at each crank angle.

In the present embodiment, by referring to an unburning condition shaft torque data in which a relationship between the crank angle θd and the shaft torque in unburning Tcrk_mot is set, the unburning shaft torque calculation unit 53 calculates the shaft torque in unburning Tcrk_mot corresponding to each crank angle.

The unburning condition shaft torque data is preliminarily set based on the experimental data, and is stored in the storage apparatus 91 such as ROM or EEPROM. As described later, the unburning condition shaft torque data which is updated based on the actual shaft torque in unburning Tcrkd may be used.

The unburning condition shaft torque data is set for every operating condition which influences at least the cylinder pressure and the reciprocation inertia torque of the piston. By referring to the unburning condition shaft torque data corresponding to the present operating condition, the unburning shaft torque calculation unit 53 calculates the shaft torque in unburning Tcrk_mot corresponding to each crank angle θd.

In the present embodiment, the operating condition concerning setting of the unburning condition shaft torque data is set to any one or more of the rotational speed of the internal combustion engine, the intake gas amount in the cylinder, the temperature, and the opening and closing timing of one or both of the intake valve and the exhaust valve. The rotational speed of the internal combustion engine corresponds to the crank angle speed ωd. As the intake gas amount in the cylinder, the gas amount of EGR gas and air taken into the cylinder, the charging efficiency, the gas pressure in intake pipe (in this example, the pressure in the intake manifold), or the like is used. As the temperature, the gas temperature taken into the cylinder, the cooling water temperature, the oil temperature, or the like is used. As the opening and closing timing of the intake valve, the opening and closing timing of the intake valve by the intake variable valve timing mechanism 14 is used. As the opening and closing timing of the exhaust valve, the opening and closing timing of the exhaust valve by the exhaust variable valve timing mechanism 15 is used.

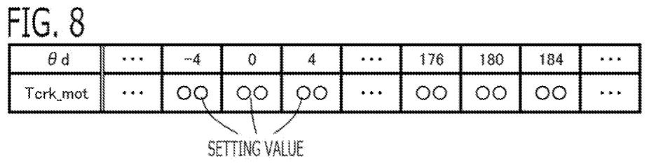

For example, as the unburning condition shaft torque data, the map data in which a relationship between the crank angle θd and the shaft torque in unburning Tcrk_mot as shown in FIG. 8 is set for every operating condition is stored in the storage apparatus 91. An approximation equation such as a polynomial may be used instead of the map data. Alternatively, as the unburning condition shaft torque data, a high order function, such as a neural network to which a plurality of operating conditions and the crank angle θd are inputted and which outputs the shaft torque in unburning Tcrk_mot, may be used.

The unburning shaft torque calculation unit 53 updates the unburning condition shaft torque data by the actual shaft torque in unburning Tcrkd calculated at each crank angle θd in the unburning condition of the internal combustion engine. For example, the unburning shaft torque calculation unit 53 refers to the unburning condition shaft torque data stored in the storage apparatus 91 and reads out the shaft torque in unburning Tcrk corresponding to the crank angle θd of the update object; and changes the shaft torque in unburning Tcrk of the crank angle θd of the update object which is set in the unburning condition shaft torque data stored in the storage apparatus 91, so that the read shaft torque in unburning Tcrk approaches the actual shaft torque in unburning Tcrkd calculated at the crank angle θd of the update object.

### <Shifting Compensation of Condition of Intake Gas Amount in Cylinder>

The specific condition of the intake gas amount in cylinder corresponding to the referred unburning condition shaft torque data may shift to the present condition of the intake gas amount in cylinder. In this case, the unburning shaft torque calculation unit 53 calculates a generated torque of unburning assumption which is a torque generated by a gas pressure in cylinder and a reciprocating movement of piston when assuming that it is the specific condition of the intake gas amount in cylinder corresponding to the referred unburning condition shaft torque data and it is unburning condition, using a physical model equation of a crank mechanism, at each crank angle θd. Herein, as the specific condition of the intake gas amount in cylinder, the operating condition at the time of measurement of the referred unburning condition shaft torque data is used.

The unburning shaft torque calculation unit 53 calculates the gas pressure torque generated by the gas pressure in cylinder when assuming that the internal combustion engine is unburning condition, using a physical model equation which calculates the gas pressure torque generated by the gas pressure in cylinder, based on the specific condition of the intake gas amount in cylinder, at each crank angle θd.

Then, the unburning shaft torque calculation unit 53 calculates the generated torque of unburning assumption in the specific condition of the intake gas amount in cylinder, by totaling the gas pressure torque and the inertia torque, at each crank angle θd.

On the other hand, the unburning shaft torque calculation unit 53 calculates the generated torque of unburning assumption in the present condition of the intake gas amount in cylinder which is a torque generated by the gas pressure in cylinder and the reciprocating movement of piston when assuming that it is unburning in the present condition of the intake gas amount in cylinder, using the physical model equation of the crank mechanism, at each crank angle θd.

The unburning shaft torque calculation unit 53 calculates the gas pressure torque generated by the gas pressure in cylinder when assuming that the internal combustion engine is unburning condition, using a physical model equation which calculates the gas pressure torque generated by the gas pressure in cylinder, based on the present condition of the intake gas amount in cylinder, at each crank angle θd.

Then, the unburning shaft torque calculation unit 53 calculates the generated torque of unburning assumption in the present condition of the intake gas amount in cylinder, by totaling the gas pressure torque and the inertia torque, at each crank angle θd.

The unburning shaft torque calculation unit 53 calculates a torque difference by subtracting the generated torque of unburning assumption in the specific condition of the intake gas amount in cylinder from the shaft torque in unburning Tcrk_mot calculated with reference to the unburning condition shaft torque data, and calculates the final shaft torque in unburning Tcrk_mot by adding the torque difference to the generated torque of unburning assumption in the present condition of the intake gas amount in cylinder, at each crank angle θd.

### 1-2-4. External Load Torque Calculation Unit 54

The external load torque calculation unit 54 calculates the external load torque Tload which is a torque applied to the crankshaft from the outside of the internal combustion engine, based on the shaft torque in unburning Tcrk_mot_tdc at the crank angle θd_tdc in the vicinity of the top dead center of the combustion stroke, and the actual shaft torque Tcrkd_brn_tdc obtained by multiplying the inertia moment Icrk of the crankshaft system to the crank angle speed αd_tdc at the crank angle θd_tdc in the vicinity of the top dead center.

In the present embodiment, as explained using the equation (8), the external load torque calculation unit 54 calculates the external load torque Tload by subtracting the actual shaft torque in burning Tcrkd_brn_tdc of the vicinity of the top dead center from the shaft torque in unburning Tcrk_mot_tdc of the vicinity of the top dead center, as shown in the next equation.

Tload=Tcrk_mot_tdc−Tcrkd_brn_tdc (9)

The crank angle θd_tdc in the vicinity of the top dead center is preliminarily set to a crank angle in the vicinity of the top dead center between the compression stroke and the combustion stroke. Herein, the vicinity of the top dead center is within an angle interval from 10 degrees before the top dead center to 10 degrees after the top dead center, for example. For example, the crank angle θd_tdc in the vicinity of the top dead center is preliminarily set to the crank angle of the top dead center.

### 1-2-5. Combustion Index Calculation Unit 55

As shown in the next equation, in an integration crank angle interval which is set corresponding to a combustion period, the combustion index calculation unit 55 calculates a subtraction value of each crank angle by subtracting the external load torque Tload from the shaft torque in unburning Tcrk_mot(n) of each crank angle θd(n), calculates a division value of each crank angle by dividing the subtraction value of each crank angle by the inertia moment Icrk, and calculates a combustion state index αindex by integrating a value obtained by subtracting the division value of each crank angle from the crank angle acceleration αd(n) of each crank angle θd(n). Herein, nst is the angle identification number n corresponding to the start crank angle θst of the integration crank angle interval, and nend is the angle identification number n corresponding to the end crank angle θend of the integration crank angle interval.

$$α index = {\sum }_{n = nst}^{nend} \{ α d ( n ) - \frac{Tcrk\_mot ( n ) - Tload}{Icrk} \} \qquad ( 10 )$$

If the equation (10) is deformed using the equation (6) and the equation (7), the next equation is obtained. That is to say, the combustion state index αindex calculated by the equation (10) corresponds to an integration value obtained by integrating a value obtained by dividing the increment of gas pressure torque by burning ΔTgas_brn by the inertia moment Icrk, in the integration crank angle interval which is set corresponding to the combustion period.

$$αindex = {\sum }_{n = nst}^{nend} \frac{Tcrkd\_brn ( n ) - Tcrk\_mot ( n ) + Tload}{Icrk} = {\sum }_{n = nst}^{nend} \frac{Δ Tgas\_brn ( n )}{Icrk} \qquad ( 11 )$$

The equation (11) may be used instead of the equation (10). Alternatively, as the combustion state index, using an equation obtained by multiplying the inertia moment Icrk to the right side of the equation (10) or the equation (11), an integration value of the increment of gas pressure torque by burning ΔTgas_brn may be calculated. All are mathematically equivalent and have equivalent physical meanings.

The increment of gas pressure torque by burning ΔTgas_brn is a torque generated by the increase in the gas pressure (the cylinder internal pressure) by burning as shown in FIG. 7, and is basically become 0 except the combustion period. Accordingly, the integration value of ΔTgas_brn in the integration crank angle interval corresponding to the combustion period corresponds to a work load by burning in one combustion cycle. On the other hand, the indicated mean effective pressure IMEP corresponds to a work load in one combustion cycle obtained by integrating the cylinder internal pressure about the cylinder volume, and mainly becomes a value according to the integration value of the increment of cylinder pressure by burning. Therefore, the integration value of ΔTgas_brn corresponds to the indicated mean effective pressure IMEP. Accordingly, as shown in the next equation, a value obtained by multiplying a predetermined gain A to the combustion state index αindex, and adding a predetermined offset B corresponds to the indicated mean effective pressure IMEP. Accordingly, an equivalent value of the indicated mean effective pressure IMEP can be calculated by the combustion state index αindex, and the combustion state can be evaluated.

IMEP=A·αindex+B (12)

In order to improve calculation accuracy of the equivalent value of the indicated mean effective pressure IMEP, the integration crank angle interval needs to include the combustion period in which the gas pressure increases by burning. The combustion index calculation unit 55 sets the start crank angle θst of the integration crank angle interval, based on the combustion start angle θcnvst. The combustion start angle θcnvst becomes just after the ignition timing, basically. Accordingly, the combustion index calculation unit 55 calculates the combustion start angle θcnvst based on at least the ignition timing, and calculates an angle obtained by advancing the combustion start angle θcnvst by a predetermined angle, as the start crank angle θst. Other operating condition of the internal combustion engines, such as the rotational speed, the intake gas amount in cylinder, and the EGR amount, may be used for calculation of the combustion start angle θcnvst. When preignition occurs, the combustion starts before ignition timing. Accordingly, when preignition occurs, the combustion index calculation unit 55 calculates an angle obtained by advancing the occurrence angle of preignition (the combustion start angle θcnvst) by a predetermined angle, as the start crank angle θst.

An angle that “αd−(Tcrk_mot−Tload)/Icrk” corresponding to ΔTgas_brn started to become larger than 0 can be determined as the combustion start angle. Accordingly, the combustion index calculation unit 55 may determine an angle that “αd−(Tcrk_mot−Tload)/Icrk” became larger than a determination value, as the combustion start angle θcnvst.

The combustion index calculation unit 55 sets the end crank angle θend of the integration crank angle interval, based on the combustion end angle θcnvend. For example, since an angle interval where the gas pressure in cylinder increases by burning is until the valve opening timing of the exhaust valve, the end crank angle θend may be set to the valve opening angle. If the variable valve timing mechanism of the exhaust valve is provided, the end crank angle θend may be set corresponding to the valve opening angle of the exhaust valve which is set by the variable valve timing mechanism. Alternatively, since the former part of the combustion period where burning is progressing is important for determining the combustion state, the end crank angle θend may be set before the valve opening timing of the exhaust valve.

In this way, by setting the integration crank angle interval corresponding to the combustion period, the equivalent value of the indicated mean effective pressure IMEP can be calculated with good accuracy, while suppressing the computation load to the minimum.

### 1-2-6. Combustion Control Unit 56

### <If Combustion State Index is Used>

The combustion control unit 56 changes one or more of control parameters including the ignition timing, the EGR amount, the fuel injection amount, and the control amount of the variable valve timing mechanism, based on the combustion state index αindex.

The control amount of the variable valve timing mechanism becomes the opening and closing timing of the exhaust valve, if the variable valve timing mechanism of the exhaust valve is controlled, and becomes the opening and closing timing of the intake valve, if the variable valve timing mechanism of the intake valve is controlled. Since the combustion state index αindex is the equivalent value of the indicated mean effective pressure IMEP, well-known various kinds of the combustion controls which use the indicated mean effective pressure IMEP can be used.

For example, the combustion control unit 56 changes the control parameter so that the combustion state index αindex increases, based on the combustion state index αindex, for every combustion cycle. When the combustion state index αindex calculated in this time combustion cycle increases from the combustion state index αindex calculated in the last time combustion cycle, the combustion control unit 56 changes the control parameter in the same direction as the change direction of the control parameter which was changed based on the combustion state index αindex in the last time combustion cycle. On the other hand, when the combustion state index αindex calculated in this time combustion cycle decreases from the combustion state index αindex calculated in the last time combustion cycle, the combustion control unit 56 changes the control parameter in the direction opposite to the change direction of the control parameter which was changed based on the combustion state index αindex in the last time combustion cycle. By controlling in this way, the control parameter is changed so that the combustion state index αindex approaches the maximum value and the indicated mean effective pressure IMEP approaches the maximum value, and fuel efficiency and output can be improved. The increase and decrease of the combustion state index αindex may be evaluated about the same cylinder, or may be collectively evaluated about all cylinders.

### <If Variation Degree of Combustion State Index is Used>

Alternatively, the combustion control unit 56 may calculate a variation degree of a plurality of combustion state indexes αindex calculated in the integration crank angle intervals of a plurality of combustion cycles, and may change one or more of control parameters including the ignition timing, the EGR amount, the fuel injection amount, and the control amount of the variable valve timing mechanism, based on the variation degree.

For example, the combustion control unit 56 changes the control parameter so that the variation degree becomes less than or equal to a determination value, for every the plurality of combustion cycles. When the variation degree calculated this time becomes larger than the determination value, the combustion control unit 56 changes the control parameter in a direction where the variation degree decreases. The direction where the variation degree decreases is preliminarily set about each control parameter. By controlling in this way, the control parameter is changed so that the variation degree of the combustion state index αindex becomes less than or equal to the determination value, and the variation degree of the indicated mean effective pressure IMEP decreases, and the combustion state can be stabilized. The variation degree of the combustion state index αindex may be evaluated about the same cylinder, or may be collectively evaluated about all cylinders.

For example, the combustion control unit 56 calculates a combustion variation rate by dividing a standard deviation σ of the combustion state indexes αindex of the plurality of combustion cycles by an average value of the plurality of combustion state indexes αindex, as the variation degree of the plurality of combustion state indexes αindex. The combustion variation rate corresponds to the combustion variation rate COV of the indicated mean effective pressure. Accordingly, well-known various kinds of the combustion controls which use the combustion variation rate COV of the indicated mean effective pressure can be used.

The combustion control unit 56 may execute the change of the control parameter based on the combustion state index αindex, and the change of the control parameter based on the variation degree of the combustion state index αindex in parallel. In this case, the combustion control unit 56 executes the change of the control parameter based on the variation degree, when the variation degree is larger than the determination value, and executes the change of the control parameter based on the combustion state index αindex, when the variation degree is less than or equal to the determination value.

### <Outline Flowchart of Whole Processing>

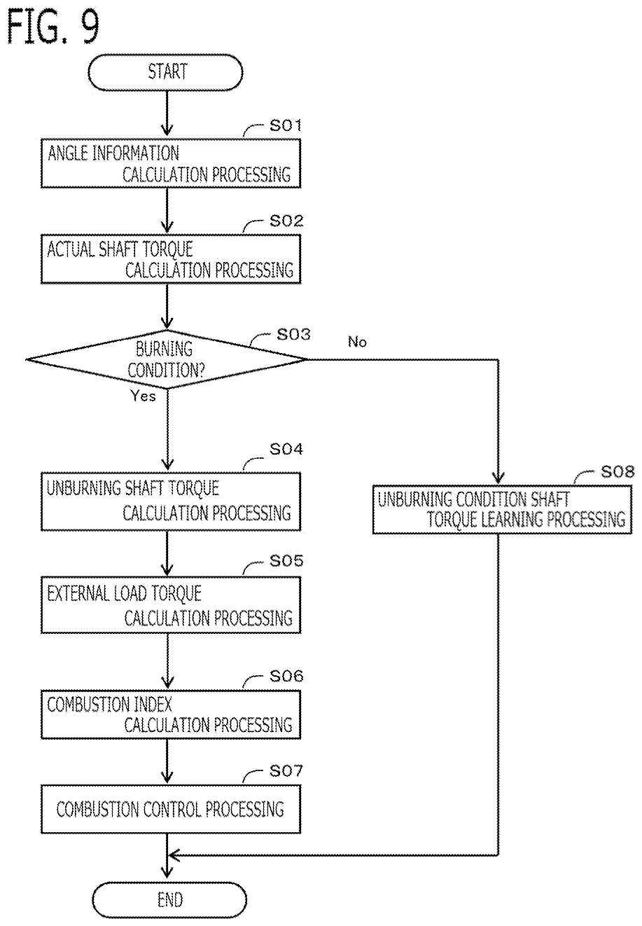

A procedure of schematic processing of the controller 50 (a control method for internal combustion engine) concerning the present embodiment will be explained based on the flow chart shown in FIG. 9. The processing of the flowchart in FIG. 9 is recurrently executed every time when detecting the crank angle θd or every predetermined operation cycle, by the arithmetic processor 90 executing software (a program) stored in the storage apparatus 91.

In the step S01, as mentioned above, the angle information detection unit 51 performs an angle information detection processing (an angle information detection step) which detects the crank angle θd, crank angle speed ωd, and the crank angle acceleration ad based on the output signal of the second crank angle sensor 6.

In the step S02, as mentioned above, the actual shaft torque calculation unit 52 performs an actual shaft torque calculation processing (an actual shaft torque calculation step) which calculates an actual shaft torque Tcrkd applied to the crankshaft, based on the detection value of crank angle acceleration ad, and the inertia moment Icrk of the crankshaft system, at each crank angle θd including a crank angle θd_tdc in the vicinity of the top dead center.

In the step S03, the controller 50 determines whether it is the burning condition of the internal combustion engine or it is the unburning condition of the internal combustion engine. When it is the burning condition, it advances to the step S04, and when it is the unburning condition, it advances to the step S08. Herein, “burning condition” and “in burning” are a condition and a time that the controller 50 controls so as to burn fuel in the combustion stroke. And, “unburning condition” and “in unburning” are a condition and a time that the controller 50 controls so as not to burn fuel in the combustion stroke.

In the step S04, as mentioned above, the unburning shaft torque calculation unit 53 performs an unburning shaft torque calculation processing (an unburning shaft torque calculation step) which calculates a shaft torque in unburning Tcrk_mot when assuming that the internal combustion engine is unburning condition in the present driving condition, at each crank angle θd.

In the step S05, as mentioned above, the external load torque calculation unit 54 performs an external load torque calculation processing (an external load torque calculation step) which calculates the external load torque Tload which is a torque applied to the crankshaft from the outside of the internal combustion engine, based on the shaft torque in unburning Tcrk_mot_tdc at the crank angle θd_tdc in the vicinity of the top dead center of the combustion stroke, and the actual shaft torque Tcrkd_brn_tdc at the crank angle θd_tdc in the vicinity of the top dead center.

In the step S06, as mentioned above, the combustion index calculation unit 55 performs a combustion index calculation processing (a combustion index calculation step) which calculates a subtraction value of each crank angle by subtracting the external load torque Tload from the shaft torque in unburning Tcrk_mot(n) of each crank angle θd(n), calculates a division value of each crank angle by dividing the subtraction value of each crank angle by the inertia moment Icrk, and calculates a combustion state index αindex by integrating a value obtained by subtracting the division value of each crank angle from the crank angle acceleration αd(n) of each crank angle θd(n), in an integration crank angle interval which is set corresponding to a combustion period.

In the step S07, as mentioned above, the combustion control unit 56 performs a combustion control processing (a combustion control step) which changes one or more of control parameters including the ignition timing, the EGR amount, the fuel injection amount, and the control amount of the variable valve timing mechanism, based on the combustion state index αindex. The combustion control unit 56 may calculate a variation degree of a plurality of combustion state indexes αindex calculated in the integration crank angle intervals of a plurality of combustion cycles, and may change one or more of control parameters including the ignition timing, the EGR amount, the fuel injection amount, and the control amount of the variable valve timing mechanism, based on the variation degree.

On the other hand, when the internal combustion engine is unburning condition, in the step S08, as mentioned above, the unburning shaft torque calculation unit 53 performs an unburning condition shaft torque learning processing (an unburning condition shaft torque learning step) which updates the unburning condition shaft torque data by the actual shaft torque in unburning Tcrkd calculated at each crank angle θd in the unburning condition of the internal combustion engine.

### 2. Embodiment 2

The controller 50 according to Embodiment 2 will be explained with reference to drawings. The explanation for constituent parts the same as those in Embodiment 1 will be omitted. The basic configuration of the controller 50 according to the present embodiment is the same as that of Embodiment 1.

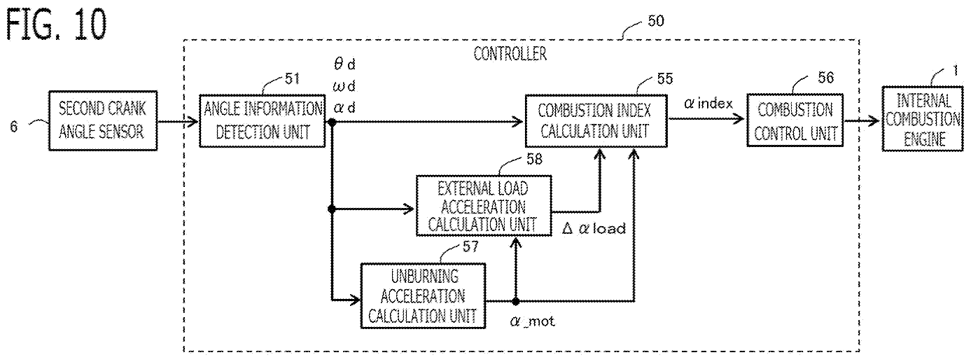

In the present embodiment, as shown in FIG. 10, the controller 50 is provided with an unburning acceleration calculation unit 57 and an external load acceleration calculation unit 58 instead of the unburning shaft torque calculation unit 53 and the external load torque calculation unit 54, and is not provided with the actual shaft torque calculation unit 52.

### 2-1. Unburning Acceleration Calculation Unit 57

The unburning acceleration calculation unit 57 calculates a crank angle acceleration in unburning α_mot when assuming that the internal combustion engine is unburning condition in the present operating condition, at each crank angle.

In the present embodiment, by referring to an unburning condition acceleration data in which a relationship between the crank angle θd and the crank angle acceleration in unburning α_mot is set, the unburning acceleration calculation unit 57 calculates the crank angle acceleration in unburning α_mot corresponding to each crank angle.

The unburning condition acceleration data is preliminarily set based on the experimental data, and is stored in the storage apparatus 91 such as ROM or EEPROM. As described later, the unburning condition acceleration data which is updated based on the crank angle acceleration ad detected in unburning may be used.

The unburning condition acceleration data is set for every operating condition which influences at least the cylinder pressure and the reciprocation inertia torque of the piston. By referring to the unburning condition acceleration data corresponding to the present operating condition, the unburning acceleration calculation unit 57 calculates the crank angle acceleration in unburning α_mot corresponding to each crank angle θd.

In the present embodiment, the operating condition concerning setting of the unburning condition acceleration data is set to any one or more of the rotational speed of the internal combustion engine, the intake gas amount in the cylinder, the temperature, and the opening and closing timing of one or both of the intake valve and the exhaust valve. Since the setting of the unburning condition acceleration data is similar to the setting of the unburning condition shaft torque data, explanation is omitted.

The unburning acceleration calculation unit 57 updates the unburning condition acceleration data by the crank angle acceleration in unburning ad calculated at each crank angle θd, in the unburning condition of the internal combustion engine. For example, the unburning acceleration calculation unit 57 refers to the unburning condition acceleration data stored in the storage apparatus 91 and reads out the crank angle acceleration in unburning α_mot corresponding to the crank angle θd of the update object; and changes the crank angle acceleration in unburning α_mot of the crank angle θd of the update object which is set in the unburning condition acceleration data stored in the storage apparatus 91, so that the read crank angle acceleration in unburning α_mot approaches the crank angle acceleration in unburning ad calculated at crank angle θd of the update object.

### <Shifting Compensation of Condition of Intake Gas Amount in Cylinder>

Similarly to the unburning shaft torque calculation unit 53, the unburning acceleration calculation unit 57 calculates a generated torque of unburning assumption which is a torque generated by a gas pressure in cylinder and a reciprocating movement of piston when assuming that it is the specific condition of the intake gas amount in cylinder corresponding to the referred unburning condition acceleration data and it is unburning condition, using a physical model equation of a crank mechanism, at each crank angle θd. Herein, as the specific condition of the intake gas amount in cylinder, the operating condition at the time of measurement of the referred unburning condition acceleration data is used.

The unburning acceleration calculation unit 57 calculates the gas pressure torque generated by the gas pressure in cylinder when assuming that the internal combustion engine is unburning condition, using a physical model equation which calculates the gas pressure torque generated by the gas pressure in cylinder, based on the specific condition of the intake gas amount in cylinder, at each crank angle θd.

Then, the unburning acceleration calculation unit 57 calculates the generated torque of unburning assumption in the specific condition of the intake gas amount in cylinder, by totaling the gas pressure torque and the inertia torque, at each crank angle θd; and calculates the crank angle acceleration of unburning assumption in the specific condition of the intake gas amount in cylinder by dividing the generated torque of unburning assumption by the inertia moment Icrk of the crankshaft system.

On the other hand, the unburning acceleration calculation unit 57 calculates the generated torque of unburning assumption in the present condition of the intake gas amount in cylinder which is a torque generated by the gas pressure in cylinder and the reciprocating movement of piston when assuming that it is unburning in the present condition of the intake gas amount in cylinder, using the physical model equation of the crank mechanism, at each crank angle θd.

The unburning acceleration calculation unit 57 calculates the gas pressure torque generated by the gas pressure in cylinder when assuming that the internal combustion engine is unburning condition, using a physical model equation which calculates the gas pressure torque generated by the gas pressure in cylinder, based on the present condition of the intake gas amount in cylinder, at each crank angle θd.

Then, the unburning acceleration calculation unit 57 calculates the generated torque of unburning assumption in the present condition of the intake gas amount in cylinder, by totaling the gas pressure torque and the inertia torque, at each crank angle θd; and calculates the crank angle acceleration of unburning assumption in the present condition of the intake gas amount in cylinder by dividing the generated torque of unburning assumption by the inertia moment Icrk of the crankshaft system.

The unburning acceleration calculation unit 57 calculates a crank angle acceleration difference by subtracting the crank angle acceleration of unburning assumption in the specific condition of the intake gas amount in cylinder from the crank angle acceleration in unburning α_mot calculated with reference to the unburning condition acceleration data; and calculates the final crank angle acceleration in unburning α_mot by adding the crank angle acceleration difference to the crank angle acceleration of unburning assumption in the present condition of the intake gas amount in cylinder.

### 2-2. External Load Acceleration Calculation Unit 58

The external load acceleration calculation unit 58 calculates an external load acceleration component Δαload which is a crank angle acceleration component by the external load torque Tload applied to the crankshaft from the outside of the internal combustion engine, based on the crank angle acceleration in unburning α_mot_tdc at the crank angle θd_tdc in the vicinity of the top dead center of the combustion stroke, and the crank angle acceleration αd_tdc at the crank angle θd_tdc in the vicinity of the top dead center.

The next equation corresponds to an equation obtained by dividing the equation (9) by the inertia moment Icrk of the crankshaft system. The external load acceleration calculation unit 58 calculates the external load acceleration component Δαload by subtracting the crank angle acceleration αd_tdc in the vicinity of the top dead center from the crank angle acceleration in unburning α_mot_tdc in the vicinity of the top dead center, as shown in the next equation.

Δαload=α_mot_tdc−αd_tdc (3)

### 2-3. Combustion Index Calculation Unit 55

The next equation is mathematically equivalent to the equation (10). As shown in the next equation, in an integration crank angle interval which is set corresponding to a combustion period, the combustion index calculation unit 55 calculates a subtraction value of each crank angle by subtracting the crank angle acceleration in unburning α_mot(n) of each crank angle θd(n) from the crank angle acceleration αd(n) of each crank angle θd(n), and calculates a combustion state index αindex by integrating a value obtained by adding the external load acceleration component Δαload to the subtraction value of each crank angle. Herein, nst is the angle identification number n corresponding to the start crank angle θst of the integration crank angle interval, and nend is the angle identification number n corresponding to the end crank angle θend of the integration crank angle interval.

$$αindex = {\sum }_{n = nst}^{nend} \{ α d ( n ) - α\_mot ( n ) + Δ αload \} \qquad ( 14 )$$

As explained in Embodiment 1, since the equation (14) is mathematically equivalent to the equation (11), the equation (11) may be used instead of the equation (14).

As explained in Embodiment 1, an equivalent value of the indicated mean effective pressure IMEP can be calculated by the combustion state index αindex, and the combustion state can be evaluated.

Similarly to Embodiment 1, the combustion index calculation unit 55 sets the start crank angle θst of the integration crank angle interval, based on the combustion start angle θcnvst. The combustion start angle θcnvst becomes just after the ignition timing, basically. Accordingly, the combustion index calculation unit 55 calculates the combustion start angle θcnvst based on at least the ignition timing, and calculates an angle obtained by advancing the combustion start angle θcnvst by a predetermined angle, as the start crank angle θst. Other operating condition of the internal combustion engines, such as the rotational speed, the intake gas amount in cylinder, and the EGR amount, may be used for calculation of the combustion start angle θcnvst. When preignition occurs, the combustion starts before ignition timing. Accordingly, when preignition occurs, the combustion index calculation unit 55 calculates an angle obtained by advancing the occurrence angle of preignition (the combustion start angle θcnvst) by a predetermined angle, as the start crank angle θst.

An angle that “αd−α_mot+Δαload” corresponding to ΔTgas_brn started to become larger than 0 can be determined as the combustion start angle. Accordingly, the combustion index calculation unit 55 may determine an angle that “αd−α_mot+Δαload” became larger than a determination value, as the combustion start angle θcnvst.

The combustion index calculation unit 55 sets the end crank angle θend of the integration crank angle interval, based on the combustion end angle θcnvend. For example, since an angle interval where the gas pressure in cylinder increases by burning is until the valve opening timing of the exhaust valve, the end crank angle θend may be set to the valve opening angle. If the variable valve timing mechanism of the exhaust valve is provided, the end crank angle θend may be set corresponding to the valve opening angle of the exhaust valve which is set by the variable valve timing mechanism. Alternatively, since the former part of the combustion period where burning is progressing is important for determining the combustion state, the end crank angle θend may be set before the valve opening timing of the exhaust valve.

In this way, by setting the integration crank angle interval corresponding to the combustion period, the equivalent value of the indicated mean effective pressure IMEP can be calculated with good accuracy, while suppressing the computation load to the minimum.

### <Outline Flowchart of Whole Processing>

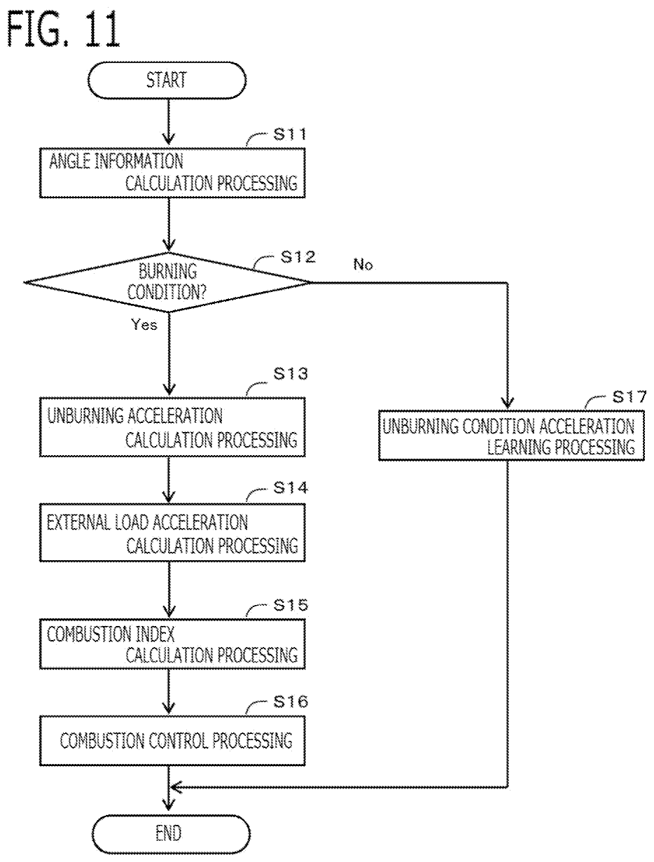

A procedure of schematic processing of the controller 50 (a control method for internal combustion engine) concerning the present embodiment will be explained based on the flow chart shown in FIG. 11. The processing of the flowchart in FIG. 11 is recurrently executed every time when detecting the crank angle θd or every predetermined operation cycle, by the arithmetic processor 90 executing software (a program) stored in the storage apparatus 91.

In the step S11, as mentioned above, the angle information detection unit 51 performs an angle information detection processing (an angle information detection step) which detects the crank angle θd, crank angle speed ωd, and the crank angle acceleration ad based on the output signal of the second crank angle sensor 6.

In the step S12, the controller 50 determines whether it is the burning condition of the internal combustion engine or it is the unburning condition of the internal combustion engine. When it is the burning condition, it advances to the step S13, and when it is the unburning condition, it advances to the step S17.

In the step S13, as mentioned above, the unburning acceleration calculation unit 57 performs an unburning acceleration calculation processing (an unburning acceleration calculation step) which calculates a crank angle acceleration in unburning α_mot when assuming that the internal combustion engine is unburning condition in the present operating condition, at each crank angle.

In the step S14, as mentioned above, the external load acceleration calculation unit 58 performs an external load acceleration calculation processing (an external load acceleration calculation step) which calculates an external load acceleration component Δαload which is a crank angle acceleration component by the external load torque Tload applied to the crankshaft from the outside of the internal combustion engine, based on the crank angle acceleration in unburning α_mot_tdc at the crank angle θd_tdc in the vicinity of the top dead center of the combustion stroke, and the crank angle acceleration αd_tdc at the crank angle θd_tdc in the vicinity of the top dead center.

In the step S15, as mentioned above, the combustion index calculation unit 55 performs a combustion index calculation processing (a combustion index calculation step) which calculates a subtraction value of each crank angle by subtracting the crank angle acceleration in unburning α_mot(n) of each crank angle θd(n) from the crank angle acceleration αd(n) of each crank angle θd(n), and calculates a combustion state index αindex by integrating a value obtained by adding the external load acceleration component Δαload to the subtraction value of each crank angle, in an integration crank angle interval which is set corresponding to a combustion period.

In the step S16, as mentioned above, the combustion control unit 56 performs a combustion control processing (a combustion control step) which changes one or more of control parameters including the ignition timing, the EGR amount, the fuel injection amount, and the control amount of the variable valve timing mechanism, based on the combustion state index αindex. The combustion control unit 56 may calculate a variation degree of a plurality of combustion state indexes αindex calculated in the integration crank angle intervals of a plurality of combustion cycles, and may change one or more of control parameters including the ignition timing, the EGR amount, the fuel injection amount, and the control amount of the variable valve timing mechanism, based on the variation degree.

On the other hand, when the internal combustion engine is unburning condition, in the step S17, as mentioned above, the unburning acceleration calculation unit 57 performs an unburning condition acceleration learning processing (an unburning condition acceleration learning step) which updates the unburning condition acceleration data by the crank angle acceleration in unburning ad calculated at each crank angle θd, in the unburning condition of the internal combustion engine.

### Example of Conversion

(1) In each of the above-mentioned Embodiments, there was explained the case where the crank angle θd, the crank angle speed ωd, and the crank angle acceleration ad are detected based on the output signal of the second crank angle sensor 6. However, based on the output signal of the first crank angle sensor 11, the crank angle θd, the crank angle speed ωd, and the crank angle acceleration ad may be detected.

(2) In each of the above-mentioned Embodiments, there was explained the case where the 3-cylinder engine whose cylinder number is three is used. However, the engine of any cylinder numbers (for example, 1-cylinder, 2-cylinder, 4-cylinder, 6-cylinder) may be used.

(3) In each of the above-mentioned Embodiments, there was explained the case where the internal combustion engine 1 is a gasoline engine. However, embodiments of the present disclosure are not limited to the foregoing case. That is to say, the internal combustion engine 1 may be various kinds of internal combustion engines, such as a diesel engine and an engine which performs HCCI combustion (Homogeneous-Charge Compression Ignition Combustion).

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### REFERENCE SIGNS LIST

1: Internal Combustion Engine, 2: Crankshaft, 6: Second Crank Angle Sensor, 50: Controller for Internal Combustion Engine, 51: Angle Information Detection Unit, 52: Actual Shaft Torque Calculation Unit, 53: Unburning Shaft Torque Calculation Unit, 54: External Load Torque Calculation Unit, 55: Combustion Index Calculation Unit, 56: Combustion Control Unit, 57: Unburning Acceleration Calculation Unit, 58: External Load Acceleration Calculation Unit, Icrk: Inertia moment, Tcrk_mot: Shaft torque in unburning, Tcrkd: Actual shaft torque, Tload: External load torque, αd: Crank angle acceleration, α_mot: Crank angle acceleration in unburning, Δαload: External load acceleration component, αindex: Combustion state index, θcnvend: Combustion end angle, θcnvst: Combustion start angle, θd: Crank angle, θend: End crank angle, θst: Start crank angle

What is claimed is:

1. A controller for internal combustion engine comprising at least one processor configured to implement:
an angle information detector that detects a crank angle and a crank angle acceleration, based on an output signal of a crank angle sensor;
an unburning shaft torque calculator that calculates a shaft torque in unburning when assuming that an internal combustion engine is unburning condition, at each crank angle;
an external load torque calculator that calculates an external load torque which is a torque applied to a crankshaft from an outside of the internal combustion engine, based on the shaft torque in unburning at the crank angle in a vicinity of a top dead center of a combustion stroke, and an actual shaft torque obtained by multiplying an inertia moment of a crankshaft system to the crank angle acceleration at the crank angle in the vicinity of the top dead center;
a combustion index calculator that, in an integration crank angle interval which is set corresponding to a combustion period, calculates a subtraction value of each crank angle by subtracting the external load torque from the shaft torque in unburning of each crank angle, calculates a division value of each crank angle by dividing the subtraction value of each crank angle by the inertia moment, and calculates a combustion state index by integrating a value obtained by subtracting the division value of each crank angle from the crank angle acceleration of each crank angle.

2. A controller for internal combustion engine comprising at least one processor configured to implement:
an angle information detector that detects a crank angle and a crank angle acceleration, based on an output signal of a crank angle sensor;
an unburning acceleration calculator that calculates a crank angle acceleration in unburning when assuming that an internal combustion engine is unburning condition, at each crank angle;
an external load acceleration calculator that calculates an external load acceleration component which is a crank angle acceleration component by an external load torque applied to a crankshaft from an outside of an internal combustion engine, based on the crank angle acceleration in unburning at the crank angle in a vicinity of a top dead center of a combustion stroke, and the crank angle acceleration at the crank angle in the vicinity of the top dead center;
a combustion index calculator that, in an integration crank angle interval which is set corresponding to a combustion period, calculates a subtraction value of each crank angle by subtracting the crank angle acceleration in unburning of each crank angle from the crank angle acceleration of each crank angle, and calculates a combustion state index by integrating a value obtained by adding the external load acceleration component to the subtraction value of each crank angle.

3. The controller for internal combustion engine according to claim 1,
wherein the combustion index calculator sets a start crank angle of the integration crank angle interval, based on a combustion start angle.

4. The controller for internal combustion engine according to claim 1,
wherein the combustion index calculator sets an end crank angle of the integration crank angle interval, based on a combustion end angle.

5. The controller for internal combustion engine according to claim 1, further comprising
a combustion controller that changes one or more of control parameters including an ignition timing, an EGR amount, a fuel injection amount, and a control amount of a variable valve timing mechanism, based on the combustion state index.

6. The controller for internal combustion engine according to claim 1, further comprising
a combustion controller that calculates a variation degree of a plurality of the combustion state indexes calculated in the integration crank angle intervals of a plurality of combustion cycles, and changes one or more of control parameters including an ignition timing, an EGR amount, a fuel injection amount, and a control amount of a variable valve timing mechanism, based on the variation degree.

7. The controller for internal combustion engine according to claim 1,
wherein the unburning shaft torque calculator, by referring to an unburning condition shaft torque data in which a relationship between the crank angle and the shaft torque in unburning is set, calculates the shaft torque in unburning corresponding to each crank angle.

8. The controller for internal combustion engine according to claim 2,
wherein the unburning acceleration calculator, by referring to an unburning condition acceleration data in which a relationship between the crank angle and the crank angle acceleration in unburning is set, calculates the crank angle acceleration in unburning corresponding to each crank angle.

9. The controller for internal combustion engine according to claim 2,
wherein the combustion index calculator sets a start crank angle of the integration crank angle interval, based on a combustion start angle.

10. The controller for internal combustion engine according to claim 2,
wherein the combustion index calculator sets an end crank angle of the integration crank angle interval, based on a combustion end angle.

11. The controller for internal combustion engine according to claim 2, further comprising
a combustion controller that changes one or more of control parameters including an ignition timing, an EGR amount, a fuel injection amount, and a control amount of a variable valve timing mechanism, based on the combustion state index.

12. The controller for internal combustion engine according to claim 2, further comprising
a combustion controller that calculates a variation degree of a plurality of the combustion state indexes calculated in the integration crank angle intervals of a plurality of combustion cycles, and changes one or more of control parameters including an ignition timing, an EGR amount, a fuel injection amount, and a control amount of a variable valve timing mechanism, based on the variation degree.
